(19) United States
(12) Patent Application Publication
(10) Pub. No.: US 2019/0047130 A1
(43) Pub. Date: Feb. 14, 2019

(54) STAPLE GUN

(71) Applicant: PAO SHEN ENTERPRISES CO., LTD., Chang Hua (TW)

(72) Inventor: Chun-Man LAI, Chang Hua (TW)

(73) Assignee: PAO SHEN ENTERPRISES CO., LTD., Chang Hua (TW)

(21) Appl. No.: 15/848,144

(22) Filed: Dec. 20, 2017

(30) Foreign Application Priority Data
Aug. 8, 2017 (TW) 106126713

(51) Int. Cl. B25C 5/11; B25C 5/06

(52) U.S. Cl. CPC B25C 5/11; B25C 5/06

(57) ABSTRACT

A staple gun includes a base seat having a pivot shaft and a coupling shaft, a striking member disposed movably in the base seat and having a connecting hole, an elastic member engaging the connecting hole, a driving member having a slot and a linking hole that is engaged with the elastic member, and a handle. The driving member is inclined with a lower portion thereof being disposed in front of an upper portion thereof. The handle has a cam surface, and an engaging hole retaining the pivot shaft. Pivot movement of the handle toward a pressed position deforms the elastic member resiliently and moves the handle rearwardly due to a slidable contact between the cam surface and the coupling shaft.

### CROSS-REFERENCE TO RELATED APPLICATION

This application claims priority of Taiwanese Patent Application No. 106126713, filed on August 8, 2017.

### FIELD

The disclosure relates to a staple gun, and more particularly to a manual staple gun.

### BACKGROUND

Referring to FIGS. 1 and 2, Taiwanese Utility Model Patent No. 545350 discloses a conventional staple gun 1, which includes a casing 11, a striking unit 12, and a handle unit 13. The casing 11 has a coupling shaft 111 and an abutting shaft 112 disposed behind the coupling shaft 111. The striking unit 12 includes a striking member 121 that is disposed in the casing 11 and that is movable in an up-down direction, and an elastic member 122 that is disposed in the casing 11 and that has a front end engaging the striking member 121. The handle unit 13 includes a handle 131 that is pivotally connected to the coupling shaft 111 and a spring 132 that is connected between a top portion of the casing 11 and the handle 131. The handle 131 has a front end portion removably engaging an upper portion of the striking member 121.

In use, the handle 131 is pressed downwardly to lift up the upper portion of the striking member 121 and the front end of the elastic member 122, and is moved rearwardly after contacting the abutting shaft 112. The rearward movement of the handle 131 eventually results in disengagement of the front end portion of the handle 131 from the upper portion of the striking member 121. At this time, a restoring force of the elastic member 122 drives the striking member 121 to strike a staple.

However, since the disengagement of the front end portion of the handle 131 from the upper portion of the striking member 121 occurs rapidly after the rearward movement of the handle 131, the elastic member 122 is in fact not effectively deformed to build up enough restoring force to drive the striking member 121 to strike the staple, thereby resulting in relatively ineffective striking operation.

### SUMMARY

Therefore, an object of the disclosure is to provide a staple gun that can alleviate the drawback associated with the abovementioned prior art.

Accordingly, the staple gun includes a base seat, a striking member, an elastic member, a driving member, and a handle. The base seat has a pivot shaft, a coupling shaft that is disposed behind the pivot shaft, and a discharge opening. The striking member is disposed in the base seat, is movable in an up-down direction, and has opposite top and bottom ends that are respectively distal from and proximate to the discharge opening, and a connecting hole that is proximate to the top end. The elastic member is disposed in the base seat and has a front end portion that engages the connecting hole. The driving member has a lower portion and an upper portion. The lower portion is formed with a linking hole. The front end portion of the elastic member extends through the linking hole. The upper portion is disposed above the lower portion and is formed with a slot. The driving member is inclined with the lower portion being disposed in front of the upper portion, and with the lower portion cooperating with the striking member to define an acute angle therebetween. The handle has a base end segment that engages the slot removably, a press end segment that is opposite to the base end segment, a cam surface that is disposed between the base end segment and the press end segment, and an elongated engaging hole that is disposed between the base end segment and the press end segment, and that is surrounded by a hole-defining surface. The pivot shaft is retained in the engaging hole, and is in slidable contact with the hole-defining surface, such that the handle is pivotable relative to the base seat between a released position, where the base end segment is proximate to the discharge opening, and a pressed position, where the base end segment is distal from the discharge opening. The pivot movement of the handle from the released position to the pressed position moves the driving member upwardly so that the front end portion of the elastic member is deformed upwardly and so that the bottom end of the striking member is moved upwardly away from the discharge opening. During the pivot movement of the handle from the released position to the pressed position, the cam surface is in slidable contact with the coupling shaft of the base seat, thereby urging the handle to move rearwardly relative to the driving member and gradually withdrawing the base end segment of the handle from the slot. When the handle arrives at the pressed position, the base end segment of the handle is disengaged from the slot to release the driving member, so that the striking member is driven to move toward the discharge opening by a restoring force of the elastic member.

### BRIEF DESCRIPTION OF THE DRAWINGS

Other features and advantages of the disclosure will become apparent in the following detailed description of the embodiment with reference to the accompanying drawings, of which:

FIG. 1 is a sectional view of a conventional staple gun;

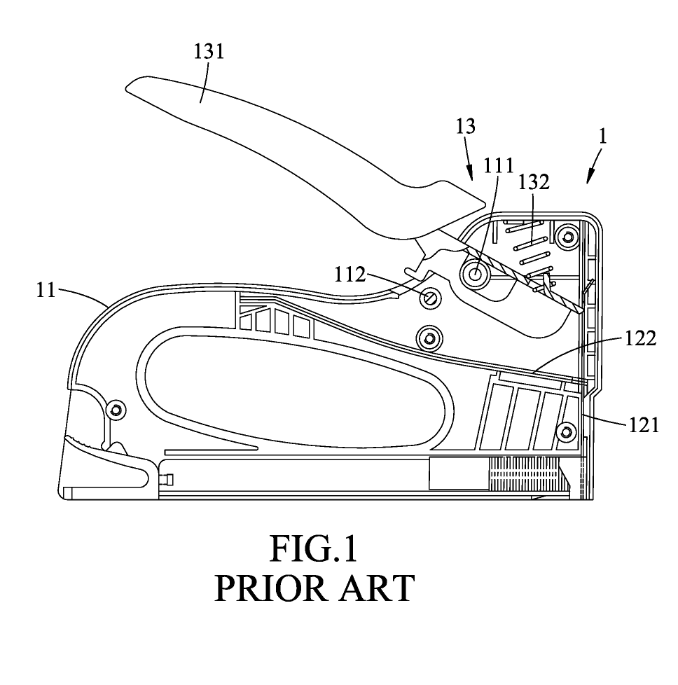

FIG. 2 is another sectional view of the conventional staple gun, illustrating a handle being pressed;

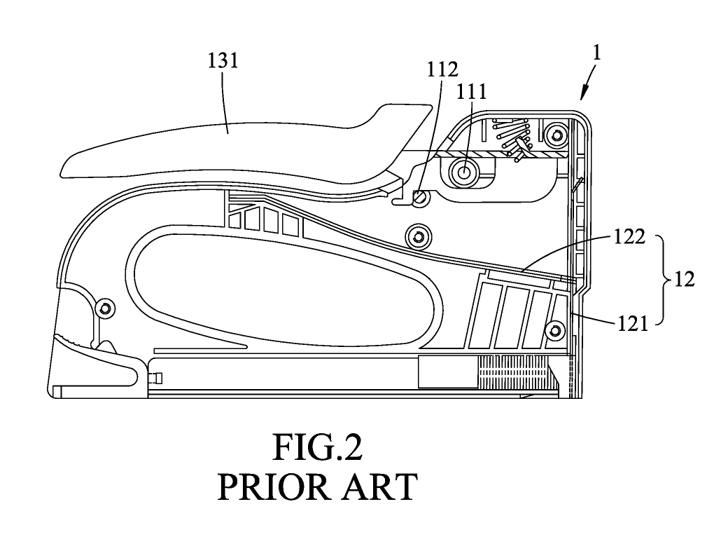

FIG. 3 is a perspective view of an embodiment of a staple gun according to the present disclosure;

FIG. 4 is an exploded perspective view of the embodiment;

FIG. 5 is a sectional view of the embodiment, illustrating a handle in a released position;

FIG. 6 is a view similar to FIG. 5, but illustrating that the handle is pressed to drive a striking member to move away from a discharge opening;

FIG. 7 is a view similar to FIG. 6, but illustrating that the handle is pivoted from the released position to a pressed position upon disengagement of the handle from a driving member; and

FIG. 8 is a view similar to FIG. 7, but illustrating that the striking member is driven to move by an elastic member via the driving member toward the discharge opening after disengagement of the handle from the driving member.

### DETAILED DESCRIPTION

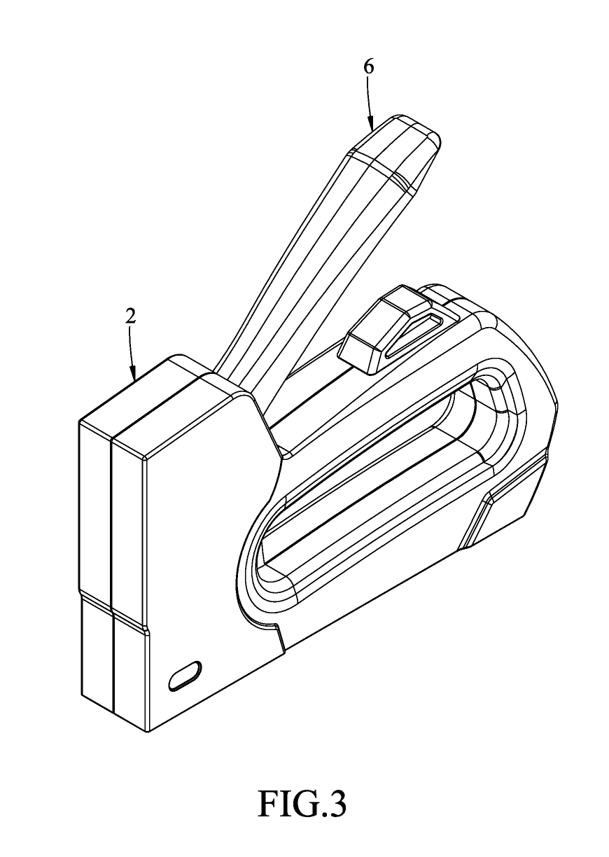

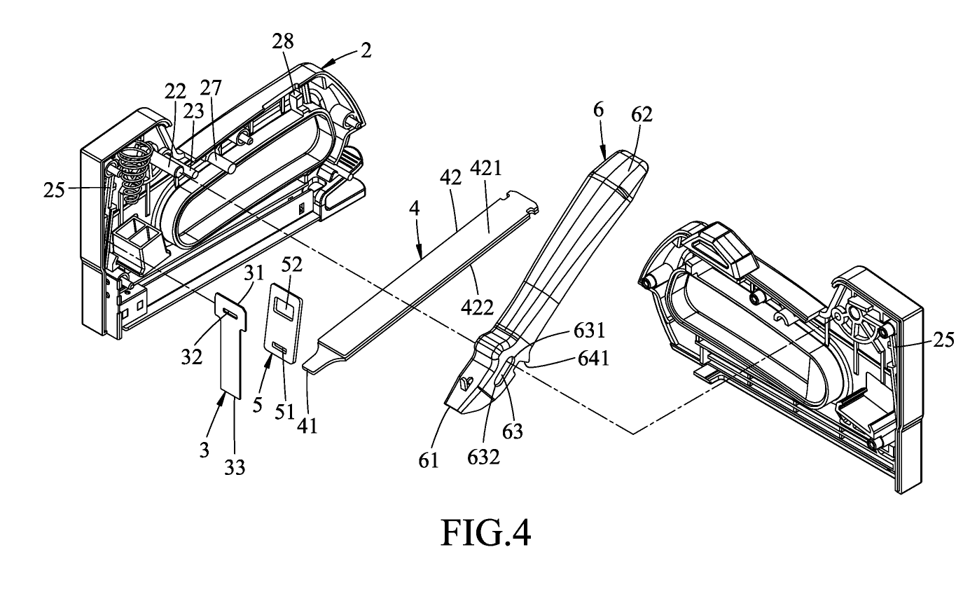

Referring to FIGS. 3 and 4, an embodiment of a staple gun according to the present disclosure includes a base seat 2, a striking member 3, an elastic member 4, a driving member 5, a handle 6, and a resilient member 7.

Referring to FIGS. 4 to 6, the base seat 2 has a pivot shaft 22, a coupling shaft 23, first and second retaining spaces, a discharge opening 26, a stop shaft 27, and a support block 28. The coupling shaft 23 is disposed behind and below the pivot shaft 22. The first retaining space has laterally opposite guide space portions 24 extending in an up-down direction (Z) and being proximate to a front portion of the base seat 2.

The second retaining space is inclined relative to the first retaining space in a manner that a bottom end of the second retaining space is in front of the top end of the second retaining space, and has laterally opposite slide space portions 25. The discharge opening 26 is proximate to a bottom front corner of the base seat 2. The stop shaft 27 is disposed behind and below the coupling shaft 23. The support block 28 is disposed behind the stop shaft 27. In this embodiment, the base seat 2 is configured as a hollow casing which includes left and right casing halves coupled together.

The striking member 3 is retained in the first retaining space of the base seat 2 with opposite lateral ends thereof being respectively slidable along the guide space portions 24 of the first retaining space in the up-down direction (Z). The striking member 3 has opposite top and bottom ends 31, 33 that are respectively distal from and proximate to the discharge opening 26, and a connecting hole 32 that is proximate to the top end 31.

The elastic member 4 is disposed in the base seat 2, and has a front end portion 41 that engages the connecting hole 32, and a rear end portion 42 that extends rearwardly from the front end portion 41. The rear end portion 42 has a top surface 421 that is in contact with the stop shaft 27, and a bottom surface 422 that is opposite to the top surface 421 and that is in contact with the support block 28.

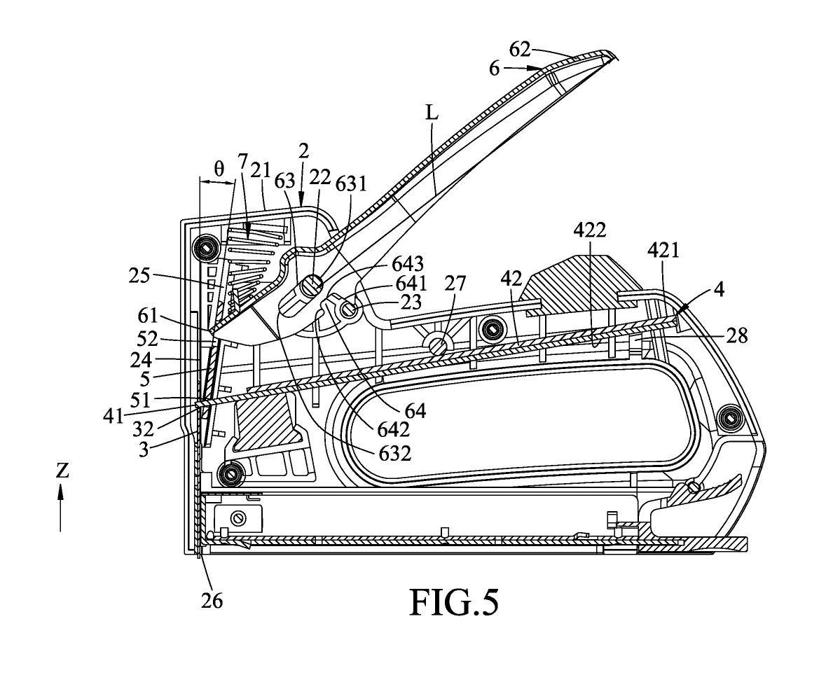

The driving member 5 is retained in the second retaining space with opposite lateral ends thereof being respectively slidable along the slide space portions 25. The driving member 5 has a lower portion that is formed with a linking hole 51, and an upper portion that is disposed above the lower portion 51 and that is formed with a slot 52. The front end portion 41 of the elastic member 4 extends through the linking hole 51 (i.e., the lower portion of the driving member 5 is disposed between the striking member 3 and the rear end portion 42 of the elastic member 4). The driving member 5 is inclined with the lower portion being disposed in front of the upper portion, and with the lower portion cooperating with the striking member 3 to define an acute angle (θ) (see FIG. 5) therebetween. In this embodiment, the acute angle (θ) is smaller than 15 degrees and is preferably 8 degrees.

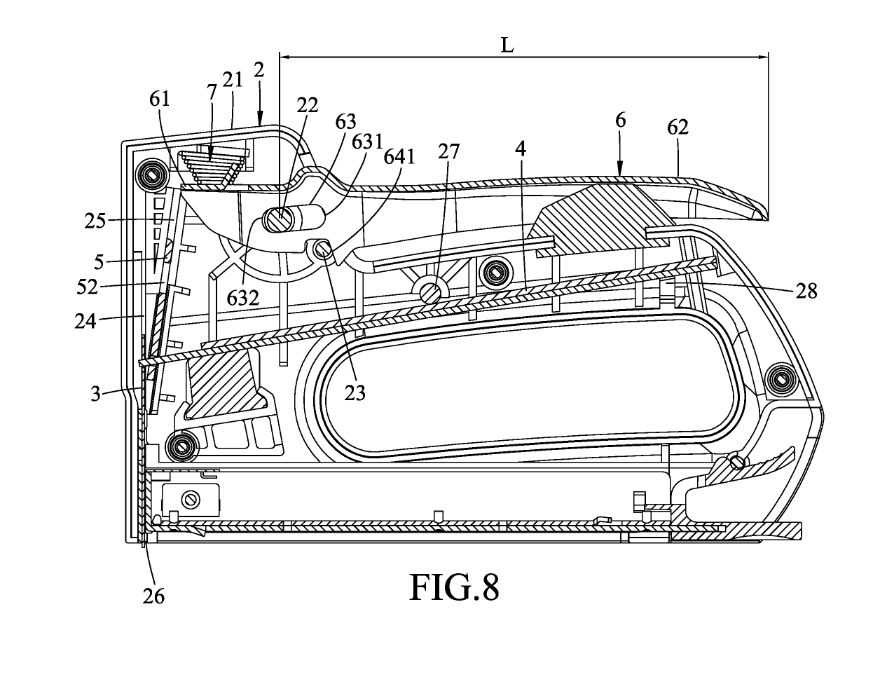

The handle 6 has a base end segment 61 that removably engages the slot 52, a press end segment 62 that is opposite to the base end segment 61, and an elongated engaging hole 63 that is disposed between the base end segment 61 and the press end segment 62. The engaging hole 63 is surrounded by a hole-defining surface, and has a first end 631, and a second end 632 that is opposite to the first end 631 and that is disposed between the first end 631 and the base end segment 61. The pivot shaft 22 of the base seat 2 is retained in the engaging hole 63, and is in slidable contact with the hole-defining surface, such that the handle 6 is pivotable relative to the base seat 2 between a released position (see FIG. 5), where the base end segment 61 is proximate to the discharge opening 26, and a pressed position (see FIG. 8), where the base end segment 61 is distal from the discharge opening 26. The handle 6 is formed with a recess 64 that faces downwardly and that is defined by a cam surface 641, a side surface 642, and an end surface 643. The cam surface 641 is disposed between the base end segment 61 and the press end segment 62. The side surface 642 is opposite to the cam surface 641. The end surface 643 interconnects the cam surface 641 and the side surface 642, and cooperates with the cam surface 641 to define an obtuse angle therebetween. In this embodiment, the obtuse angle is 109 degrees but may vary in other embodiments.

The resilient member 7 is disposed in the base seat 2, and is connected between an inner surface of the base seat 2 and the base end segment 61 of the handle 6 for biasing the handle 6 toward the released position. In this embodiment, the resilient member 7 is configured as a compression spring.

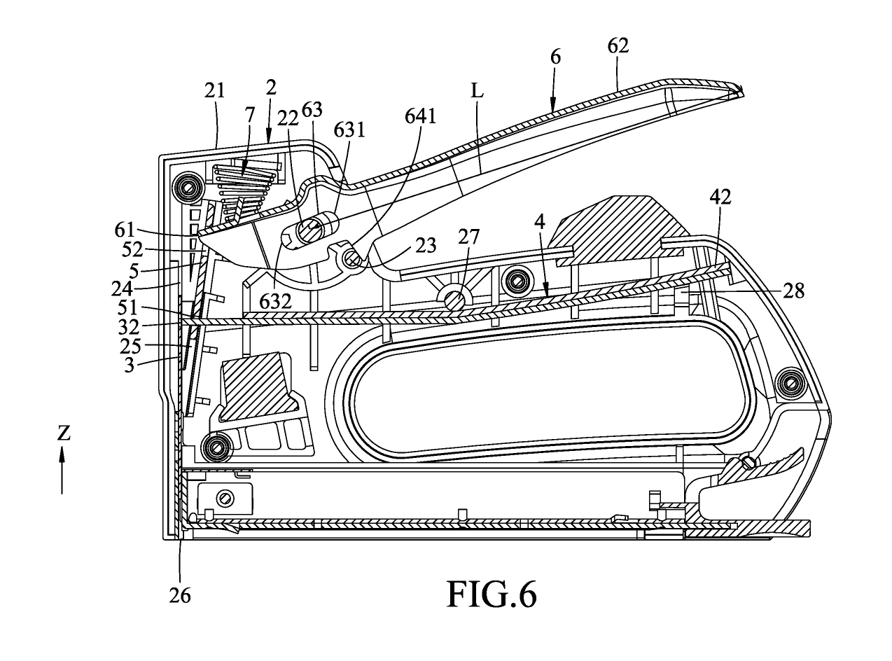

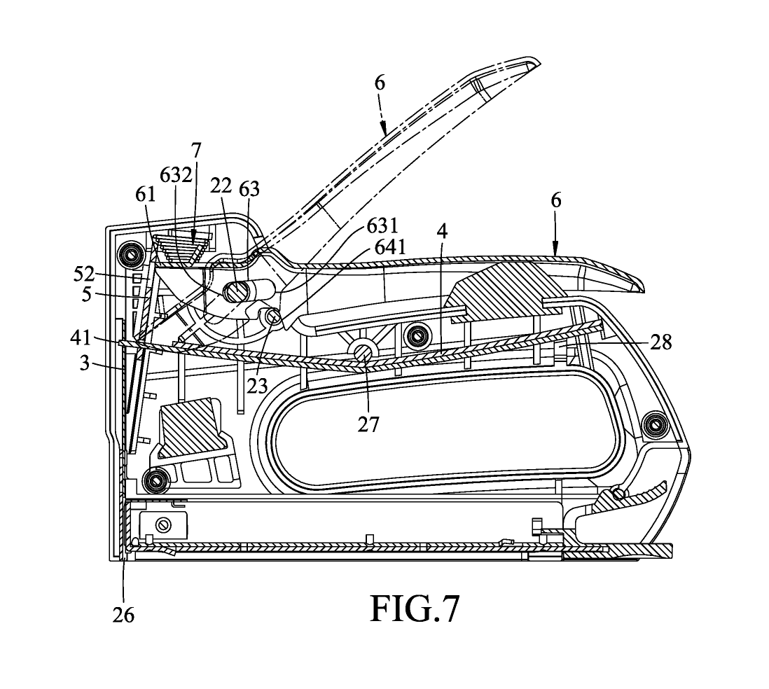

Referring to FIG. 5, when the handle 6 is in the released position, the first end 631 of the engaging hole 63 is adjacent to the pivot shaft 22 of the base seat 2, and a bottom portion of the cam surface 641 is in contact with the coupling shaft 23 of the base seat 2. Referring to FIGS. 6 and 7, the pivot movement of the handle 6 from the released position to the pressed position moves the driving member 5 upwardly, so that the front end portion 41 of the elastic member 4 is deformed upwardly to provide a restoring force, and so that the bottom end 33 of the striking member 3 is moved upwardly away from the discharge opening 26 by virtue of the connection among the striking member 3, the elastic member 4 and the driving member 5. During the pivot movement of the handle 6 from the released position to the pressed position, the cam surface 641 is in slidable contact with the coupling shaft 23 of the base seat 2, thereby urging the handle 6 to move rearwardly relative to the driving member 5 with the first end 631 of the engaging hole 63 being moved away from the pivot shaft 22, and thereby gradually withdrawing the base end segment 61 of the handle 6 from the slot 52 of the driving member 5.

Referring to FIG. 8, when the handle 6 arrives at the pressed position, the base end segment 61 of the handle 6 is disengaged from the slot 52 to release the driving member 5, so that the striking member 3 is driven to move toward the discharge opening 26 by the restoring force of the elastic member 4 to perform a striking operation. At this time, an upper portion of the cam surface 641 is in contact with the coupling shaft 23, the second end 632 of the engaging hole 63 is adjacent to the pivot shaft 22, and the resilient member 7 is pressed. After the striking operation is performed and the handle 6 is released, the resilient member 7 will return to its original state for biasing the handle 6 back to the released position.

In use, since the handle 6 moves rearwardly during the pivot movement from the released position to the pressed position, a distance (L) between a center of the pivot shaft 22 and a distal end of the press end segment 62 is gradually increased, so a user's effort required for pressing the handle 6 toward the pressed position may be decreased as well.

In this embodiment, the cam surface 641 remains in contact with the coupling shaft 23 during the whole pivot movement of the handle 6 between the released and pressed positions, but the configuration between the cam surface 641 and the coupling shaft 23 may vary in other embodiments. For example, the cam surface 641 may be proximate to the coupling shaft 23 instead of contacting the same when the handle 6 is at the beginning of the pivot movement toward the pressed position (i.e., when the handle 6 is at the released position), and the cam surface 641 may be configured to be in slidable contact with the coupling shaft 23 during at least 90 percent of the pivot movement of the handle 6 from the released position to the pressed position.

With the above description, the advantages of the staple gun according to the present disclosure can be summarized in the following:

1. Due to the slidable contact between the cam surface 641 and the coupling shaft 23 for a majority of the time during the pivot movement of the handle 6, the distance (L) between the center of the pivot shaft 22 and the distal end of the press end segment 62 of the handle 6 is effectively increased. In addition, the inclined configuration of the driving member 5 prolongs the duration of the pivot movement of the handle 6 from the released position to the pressed position before the disengagement of the base end segment 61 from the slot 52 and increases the deformation of the elastic member 4, thus the striking operation can be performed more effectively in an effort-saving manner in comparison with that of the aforesaid conventional staple gun.

2. The travel range of the pivot movement of the handle 6 can be adjusted by adjusting the acute angle (θ) between the driving member 5 and the striking member 3 during manufacturing of the staple gun of the present disclosure, thereby providing flexibility to a user.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that his disclosure is not limited to the disclosed embodiment but is intended to cover various arrangements included within the spirit and scope of the broadest interpretation so as to encompass all such modifications and equivalent arrangements.

What is claimed is:

1. A staple gun comprising:
a base seat having a pivot shaft, a coupling shaft that is disposed behind said pivot shaft, and a discharge opening;
a striking member disposed in said base seat, movable in an up-down direction, and having opposite top and bottom ends that are respectively distal from and proximate to said discharge opening, and a connecting hole that is proximate to said top end;
an elastic member disposed in said base seat and having a front end portion that engages said connecting hole;
a driving member having
a lower portion that is formed with a linking hole, said front end portion of said elastic member extending through said linking hole, and
an upper portion that is disposed above said lower portion and that is formed with a slot, said driving member being inclined with said lower portion being disposed in front of said upper portion, and with said lower portion cooperating with said striking member to define an acute angle therebetween; and
a handle having
a base end segment that engages said slot removably,
a press end segment that is opposite to said base end segment,
a cam surface that is disposed between said base end segment and said press end segment, and
an elongated engaging hole that is disposed between said base end segment and said press end segment, and that is surrounded by a hole-defining surface, said pivot shaft being retained in said engaging hole and in slidable contact with said hole-defining surface, such that said handle is pivotable relative to said base seat between a released position, where said base end segment is proximate to said discharge opening, and a pressed position, where said base end segment is distal from said discharge opening;
wherein, the pivot movement of said handle from the released position to the pressed position moves said driving member upwardly so that said front end portion of said elastic member is deformed upwardly and so that said bottom end of said striking member is moved upwardly away from said discharge opening;
wherein, during the pivot movement of said handle from the released position to the pressed position, said cam surface is in slidable contact with said coupling shaft of said base seat, thereby urging said handle to move rearwardly relative to said driving member and gradually withdrawing said base end segment of said handle from said slot; and
wherein, when said handle arrives at the pressed position, said base end segment of said handle is disengaged from said slot to release said driving member, so that said striking member is driven to move toward said discharge opening by a restoring force of said elastic member.

2. The staple gun as claimed in claim 1, wherein said cam surface of said handle is in slidable contact with said coupling shaft of said base seat during at least 90 percent of the pivot movement of said handle from the released position to the pressed position.

3. The staple gun as claimed in claim 2, wherein said cam surface of said handle is in contact with said coupling shaft of said base seat when said handle is in the released position.

4. The staple gun as claimed in claim 3, wherein:
said coupling shaft is disposed behind and below said pivot shaft;
said handle is formed with a recess that faces downwardly and that is defined cooperatively by said cam surface, a side surface, and an end surface, said side surface being opposite to said cam surface, said end surface interconnecting said cam surface and said side surface;
when said handle is in the released position, a bottom portion of said cam surface is in contact with said coupling shaft; and
when said handle is in the pressed position, an upper portion of said cam surface is in contact with said coupling shaft.

5. The staple gun as claimed in claim 4, wherein said cam surface and said end surface cooperatively define an obtuse angle therebetween.

6. The staple gun as claimed in claim 4, wherein:
said engaging hole of said handle has a first end, and a second end that is opposite to said first end and that is disposed between said first end and said base end segment of said handle;
when said handle is in the released position, said first end is adjacent to said pivot shaft; and
when said handle is in the pressed position, said second end is adjacent to said pivot shaft.

7. The staple gun as claimed in claim 1, wherein:
said base seat further has first and second retaining spaces, said first retaining space having opposite guide space portions, said second retaining space having opposite slide space portions;
said striking member is retained in said first retaining space with opposite lateral ends thereof being respectively slidable along said guide space portions of said first retaining space;
said driving member is retained in said second retaining space with opposite lateral ends thereof being respectively slidable along said slide space portions;
said staple gun further comprises a resilient member that is connected between said base seat and said handle member, and that is disposed for biasing said handle toward the released position.

8. The staple gun as claimed in claim 7, wherein:
said base seat further has a stop shaft and a support block disposed behind said stop shaft; and
said elastic member further has a rear end portion extending rearwardly from said front end portion, and having a top surface that is in contact with said stop shaft, and a bottom surface that is opposite to said top surface and that is in contact with said support block.

9. The staple gun as claimed in claim 1, wherein the actuate angle is smaller than 15 degrees.
